(19) United States
(12) Patent Application Publication
(10) Pub. No.: US 2026/0034010 A1
(43) Pub. Date: Feb. 5, 2026

(54) PORTABLE MASSAGE CHAIR CONFIGURED TO ACCOMMODATE PREGNANT AND OBESE PERSONS AND MASSAGE CHAIR TRANSPORT SYSTEM

(71) Applicant: Renee M. Estese, Maywood, IL (US)

(72) Inventor: Renee M. Estese, Maywood, IL (US)

(21) Appl. No.: 19/226,779

(22) Filed: Jun. 3, 2025

Related U.S. Application Data
(60) Provisional application No. 63/834,380, filed on Aug. 2, 2024.

(51) Int. Cl. A61G 15/00; A61G 15/12

(52) U.S. Cl. CPC A61G 15/007; A61G 15/002; A61G 15/125

(57) ABSTRACT

A massage chair comprises a frame structure, and an integrated torso support and a seat connected to the frame structure, which may be collapsible. The integrated torso support includes (a) an annular frame portion having a frame opening sized to accommodate a protruding abdomen of a pregnant or obese person, and (b) annular padding configured for removable attachment to the annular frame portion. The annular padding defines an abdominal opening sized to match or reduce the size of the frame opening. The seat is configured with a width sufficient to support a pregnant or obese person in a seated position. A massage chair transport system is also described.

### RELATED APPLICATION

The present patent document claims the benefit of priority under 35 U.S.C. 119 (e) to U.S. Provisional Patent Application No. 63/834,380, which was filed on Aug. 2, 2024, and is hereby incorporated by reference in its entirety.

### TECHNICAL FIELD

This disclosure is related generally to a massage chair and more particularly to a portable massage chair for pregnant and obese persons.

### BACKGROUND

Massage may be carried out on a patient seated in a chair configured to take weight off the spine and provide the masseuse or masseur with free access to the patient's neck, back, shoulders and arms. Such massage chairs typically employ a chest rest, a face rest and a seat so that the patient can sit in a forward-leaning position during the massage with his or her chest and face supported. A problem with existing massage chairs is that they are not able to accommodate pregnant or obese persons comfortably, as the chest rest prohibits comfortable positioning of a protruding abdomen. Furthermore, the seats of existing chairs are not configured to comfortably or reliably support the buttocks of a pregnant or obese person.

### BRIEF SUMMARY

Described in this disclosure are a massage chair and massage chair transport system intended to solve problems of existing massage chairs. It is noted that the massage chair described in this disclosure may be suitable for other uses in addition to massage, such as application of tattoos.

The massage chair comprises a frame structure, and an integrated torso support and a seat connected to the frame structure. The integrated torso support includes (a) an annular frame portion having a frame opening sized to accommodate a protruding abdomen of a pregnant or obese person, and (b) annular padding configured for removable attachment to the annular frame portion. The annular padding defines an abdominal opening sized to match or reduce the size of the frame opening. The seat is configured with a width sufficient to support a pregnant or obese person in a seated position.

A massage chair transport system comprises (a) a storage case and (b) a massage chair having a frame structure movably attached at one or more locations to an interior wall of the storage case. The frame structure is reversibly movable from a collapsed configuration to an expanded configuration while remaining attached to the interior wall. The massage chair is enclosable within the storage case when the frame structure is in the collapsed configuration, and the massage chair is usable to support a patient for a massage or other procedure when the frame structure is in the expanded configuration.

### BRIEF DESCRIPTION OF THE DRAWINGS

The embodiments may be better understood with reference to the following drawing(s) and description. The components in the figures are not necessarily to scale. Moreover, in the figures, like-referenced numerals designate corresponding parts throughout the different views.

FIG. 1 shows a perspective view of an exemplary massage chair.

FIG. 2A shows a back-side view of an exemplary integrated torso support.

FIG. 2B shows a front-side view of the integrated torso support of FIG. 2A.

FIG. 3A shows four mating strips on a front side of the annular frame portion of the integrated torso support, and FIG. 3B shows four fastening strips on a back side of the annular padding of the integrated torso support for removable attachment of the annular padding to the annular frame portion, according to one embodiment.

FIG. 4 shows an example where the annular padding has a multi-piece (e.g., two-piece) structure.

FIG. 5 shows a side view of the annular frame portion in a folded position, according to one embodiment.

FIG. 6 shows a front view of the seat and the underlying support structure.

FIG. 7 shows a perspective view of the extendable legs, which are configured for height adjustment of the chair.

FIG. 8 shows a side view of the massage chair of FIG. 1 in a folded or collapsed position for storage or transport.

FIGS. 9A and 9B show an example of a massage chair transport system suitable for storage, transport and use of a massage chair.

### DETAILED DESCRIPTION

Described in this disclosure is a portable massage chair designed to comfortably accommodate pregnant and obese persons during massage without sacrificing portability or adjustability. Also described is a massage chair transport system configured for easy storage, use and transport of a massage chair.

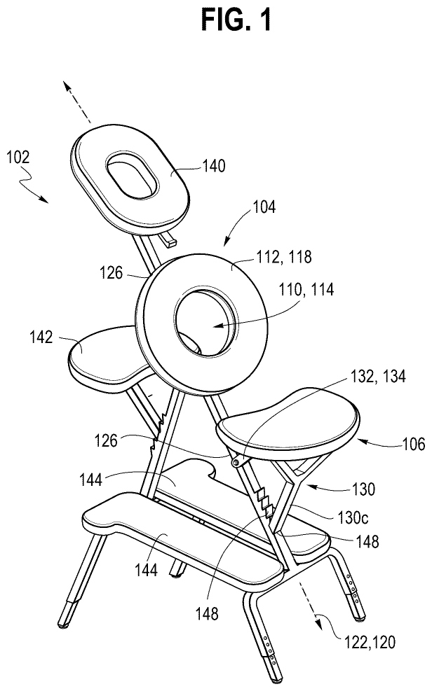

Referring to FIG. 1, the massage chair 100 comprises an integrated torso support 104 and a seat 106 connected to a frame structure 102, which may be collapsible. It is noted that FIG. 1 shows an exemplary collapsible frame structure 102; other collapsible frame structures known in the art may be employed with the integrated torso support 104 and the seat 106 described in this disclosure. The frame structure 102 may be constructed from structural members, such as tubes, struts, bars, etc., that can provide the needed strength without a significant weight penalty since the massage chair 100 is designed to be transportable. For example, the structural members may be fabricated from aluminum alloys and/or polymer composites, such as fiber-reinforced nylon.

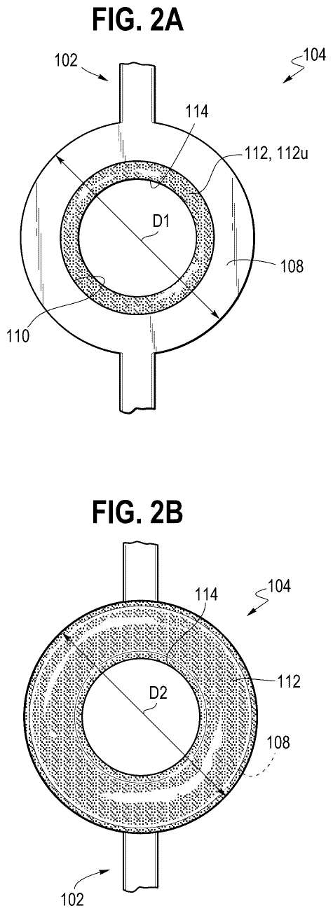

As shown in FIGS. 2A and 2B, the integrated torso support 104 includes (a) an annular frame portion 108 having a frame opening 110 sized to accommodate a protruding abdomen of the pregnant or obese person, and (b) annular padding 112 configured for removable attachment to the annular frame portion 108. FIG. 2A shows a back-side view of the annular frame portion 108 with the annular padding 112 attached to the front side, and FIG. 2A shows a front-side view of the annular frame portion 108, also with the annular padding 112 attached. The front side of the annular frame portion 108 may be understood to be the side of the annular frame portion 108 facing the pregnant or obese person, and the back side may be understood to be the other side, or the side facing away from the pregnant or obese person. This definition of “front side” and “back side” may be applied to other components of the massage chair 100. The annular padding 112 is designed to provide cushioning for regions of the torso (e.g., chest, hips) adjacent to the protruding abdomen that may be pressed against the annular frame portion 108 during the massage.

As can be seen in FIG. 2A, the annular padding 112 includes an abdominal opening 114 sized to match or reduce the size of the frame opening 110, which may in some examples have a perimeter of at least 105 cm to accommodate the abdomen of a full-term pregnant woman or a morbidly obese person. Thus, the size of the frame opening 110 may be reduced by selection and attachment of appropriately sized annular padding 112. The frame opening 110 and the abdominal opening 114 may be circular or oval/elliptical, where, in the former case, the perimeter may be a circumference.

More than one set of annular padding 112 may be provided with the massage chair 100, where each set includes an abdominal opening 112 of a different perimeter or circumference. For example, the abdominal opening 114 may have a perimeter or circumference in a range from greater than 95 cm to 105 cm, which may be suitable for a person who is 40-42 weeks pregnant. For reference, a circumference of 95 cm corresponds to a diameter of about 30 cm (or approximately 12 inches), and a circumference of 105 cm corresponds to a diameter of about 33 cm (or approximately 13 inches). In other examples, the perimeter or circumference of the abdominal opening 114 may be in the range from greater than 90 cm to 95 cm, which may be suitable for person who is 38-39 weeks pregnant, or in the range from 80 cm to 90 cm, which may be suitable for a person who is 32-24 weeks pregnant. For reference, a circumference of 90 cm corresponds to a diameter of about 29 cm (or approximately 11 inches), and a circumference of 80 cm corresponds to a diameter of about 25 cm (or approximately 10 inches). The annular padding 112 associated with each of these abdominal opening sizes may have a maximum lateral dimension D2 that preferably matches (e.g., is within 2.5 cm of) the maximum lateral dimension D1 of the annular frame portion 108 (see FIGS. 2A and 2B). In situations where the frame and abdominal openings 110,114 are circular, the maximum lateral dimension D1 or D2 may refer to a diameter of the annular frame portion 108 or the annular padding 112. Alternatively, when the frame and/or abdominal openings 110, 114 are oval or elliptical in shape, the maximum lateral dimension D1 or D2 may refer to a long axis of the annular frame portion 108 or the annular padding 112.

The annular padding 112 may comprise a cushioning material such as foam (e.g., polyurethane foam), fiber batting, polyester fiberfill, or another suitable material. Because the abdominal opening 114 may be smaller in size than the frame opening 110, the annular padding 112 may have an unsupported inner portion 112u, as illustrated in FIG. 2A, when mounted on the annular frame portion 108. To avoid collapse of the unsupported inner portion 112u in use, it may be beneficial for the annular padding 112 to be integrated with a support having a relatively high stiffness. For example, the cushioning material of the annular padding 112 may be attached to or mounted on the support. Also or alternatively, the cushioning material and optional support may be encapsulated by a cover comprising, for example, fabric, vinyl, leather, or a leather alternative. The cover may be removable.

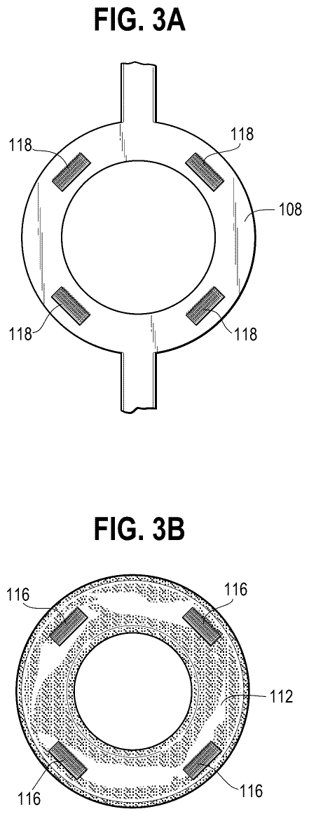

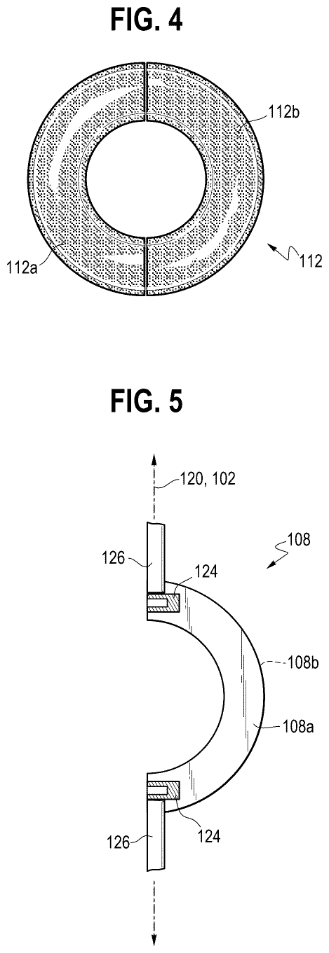

A back side of the annular padding 112 may comprise fastening strips 116 for removable attachment to mating strips 118 on a front side of the annular frame portion 108. For example, the fastening strips 116 and the mating strips 118 may comprise hook-and-loop fasteners, e.g., Velcro® strips, which may be readily connected together and detached. Alternatively, the fastening and mating strips 116, 118 may comprise other types of connections, such as holes and pegs, latches, clasps, etc. Typically, the front side of the annular frame portion 108 may include two or more, three or more, or four or more mating strips 118, preferably distributed uniformly around the circumference, as illustrated in FIG. 3A. Similarly, the back side of the annular padding 112 may include two or more, three or more, or four or more fastening strips 116 preferably distributed uniformly about the circumference, as illustrated in FIG. 3B. Advantageously, it is possible to readily swap out one set of annular padding 112 for another set having a smaller or larger opening to accommodate a pregnant or obese person of a smaller or larger size. In some examples, e.g., for portability, the annular padding 112 may be made up of multiple curved padding segments configured to form an annular shape when positioned together, end to end, as illustrated in FIG. 4 for two curved padding segments 112a, 112b.

Referring to FIG. 5, the annular frame portion 108 may be constructed to be foldable in half, typically upon removal of the annular padding 112, which may be beneficial for storage or portability. A folding axis 120 of the annular frame portion 108 may be aligned with a longitudinal axis 122 of the frame structure 102. To facilitate folding, the annular frame portion 108 may comprise two curved half segments 108a, 108b, which are rotatably connected to a frame structure main support 126 by hinges 124. The hinges 124 may be secured to a backside of the annular frame portion 108 and configured to bring the frontside of the two curved half segments 108a, 108b together.

In embodiments where the annular frame portion 108 is not foldable in half, the annular frame portion 108 may have a single-piece, monolithic structure. In such examples, the annular frame portion 108 may be integrally formed with the frame structure main support 126, or may be removably connected to the main support 126 at each end. In some examples, the annular frame portion 108 may be configured to have an adjustable position (e.g., higher or lower) with respect to the seat 106.

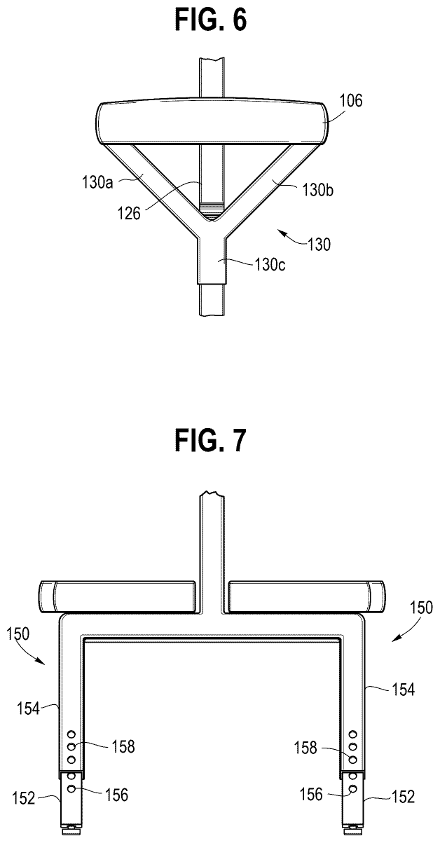

The seat 106 of the portable massage chair 100 is wider than seats on existing massage chairs, and the width is sufficient to support a pregnant or obese person in a seated position. For example, the seat 106 may have a width of at least 45 cm, or at least 50 cm, and/or up to 55 cm. To ensure the strength required to support the pregnant or obese person without sacrificing portability, the seat 106 may be reinforced with a high-strength, lightweight support structure 130. Suitable materials for the support structure 130 may include aluminum alloys and/or polymer composites, such as fiber-reinforced nylon. These materials may be employed for other components of the collapsible support structure 102 also, as mentioned above. Due to the substantial width of the seat 106, the support structure 130 may be Y-shaped with left-side and right-side support members 130a, 130b connected to or integrally formed with a central support member 130c. Referring to FIG. 6, the left-side and right-side support members 130a, 130b may extend from opposing positions on a back side of the seat 106 (e.g., along the width of the seat) to the central support member 130c. The central support member 130c may be adjustably connected to the frame structure main support 126 to raise or lower a position of the seat 106 by engaging with one of the serrations 148, as can be seen in FIG. 1. In this situation, a further support arm 132 may extend from the back side of the seat 106 to a hinged connection 134 on the main support 126, thereby keeping the seat 106 secured to the collapsible frame 102 as the seat 106 is raised or lowered.

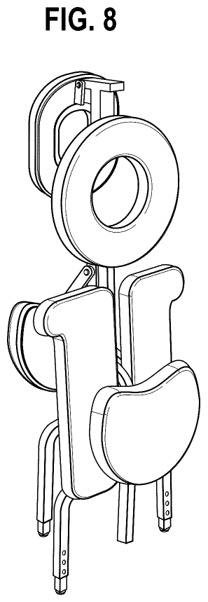

The massage chair 100 may further include extendable legs 150 that allow the height of the chair 100 to be adjusted for further comfort during the massage, as shown according to one example in FIG. 7. With proper height adjustment of the chair, the masseuse or masseur may be more comfortably able to access targeted body regions (e.g., shoulders) during the massage. More specifically, each leg 150 of the collapsible frame structure 102 may comprise telescoping members 152,154 whose relative position may be adjusted and locked into place as desired to allow the height of the chair 100 to change by as little as about 5 cm and as much as about 25 cm. The inner telescoping member 152 may include push pins 156 configured to allow telescopic sliding when pressed and to lock into holes 158 in the outer telescoping member 154 when depressed, thereby enabling the desired height adjustment.

In addition to the integrated torso support 104, the seat 106, and the extendable legs 150, the massage chair 100 may further include a face rest 140, an arm rest(s) 142 and a leg rest(s) 144 attached to the collapsible frame structure 102, as illustrated in FIG. 1 according to one example. Other frame structures, face rests, arm rest(s) and leg rest(s) known in the art may be employed with the integrated torso support 104, seat 106 and extendable legs 150 described in this disclosure.

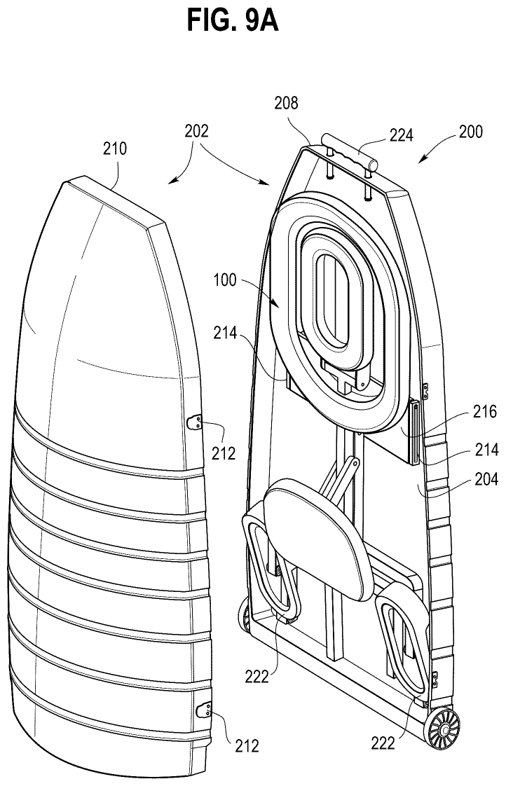

For storage and/or transport, the massage chair 100 may be collapsed or folded as illustrated in FIG. 8. Other collapsed configurations may be utilized depending on the design of the collapsible frame structure 102, which, as indicated above, need not precisely match the specific example provided in this disclosure. It is understood that a collapsible frame structure 102 is configured with frame components and hinges or other connectors that allow for collapse/folding of the frame structure 102 to a reduced size. In the collapsed configuration, the massage chair may be packed into a carry bag equipped with handles and/or wheels. In some examples, the massage chair 100 may be integrated with a storage case as described below. Advantageously, a total weight of the massage chair 100 may be less about 30 lb, or less than about 25 lb to promote portability.

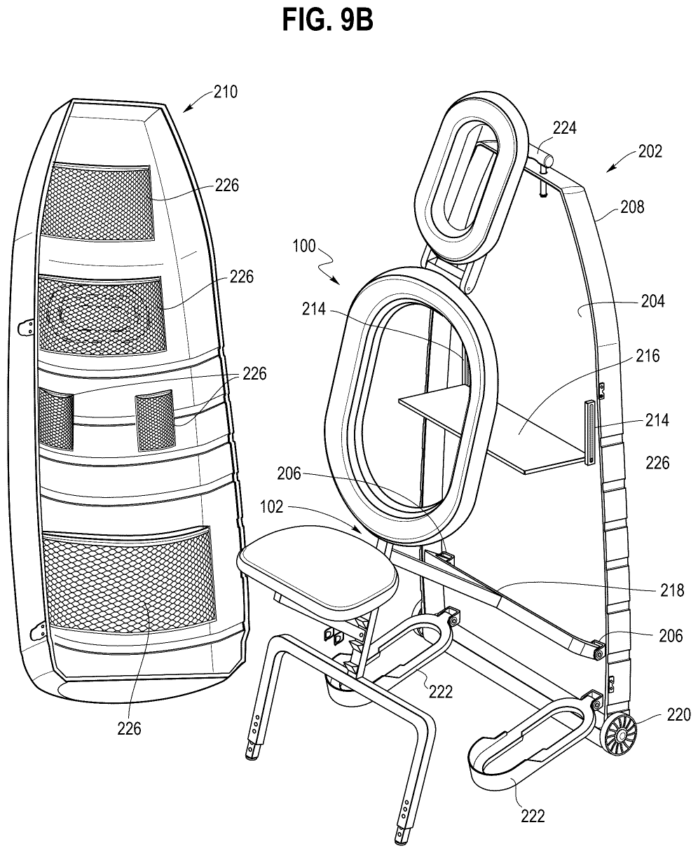

An example of a massage chair transport system suitable for storage, transport and use of a massage chair is shown in FIGS. 9A and 9B. The massage chair transport system 200 includes a storage case 202 and a massage chair 100 having a frame structure 102 moveably attached to an interior wall 204 of the storage case 202 at one or more locations, e.g., via connectors 206. The frame structure 102 is reversibly movable from a collapsed configuration (see FIG. 9A) to an expanded configuration (see FIG. 9B) while remaining attached to the interior wall 204 of the storage case 202. The connectors 206 may allow for motion of the frame structure 102 away from the interior wall 204 to reach the expanded configuration and toward the interior wall 204 to reach the collapsed configuration. As shown in FIG. 9A, the massage chair 100 is enclosable within the storage case 202 when the frame structure 102 is in the collapsed configuration, and, referring to FIG. 9B, the massage chair 100 is usable to support a patient for a massage or other procedure when the frame structure 102 is in the expanded configuration.

In this disclosure, a component that is described as being “movably attached” or “movably connected” to another part may be understood to be connected directly or indirectly (e.g., via one or more additional components) to the part in such a way that the component can be moved with respect to the part while also remaining attached to the part. The motion may include pivotal motion, rotational motion, translational motion, and/or sliding motion. The component may be movably attached or connected to the part utilizing one or more connectors (e.g., the connectors 206 mentioned above), which may take the form of hinge joints, pivot connectors, ball-and-socket joints, linear motion slides and/or other suitable connectors.

Referring again to FIGS. 9A and 9B, the frame structure 102 includes a support portion 218 movably connected to the interior wall 204 of the storage case 202 and movably attached to a backside of the frame structure 102 to facilitate collapse or expansion of the frame structure 102. The support portion 218 may take the form of a Y-shaped structural member as illustrated in FIGS. 9A and 9B. One end of the support portion 218 (e.g., the bottom of the Y-shaped structural member) may be movably connected to the backside of the frame structure 102 by a hinge joint or other connector 206 that allows for motion (e.g., pivotal motion) of the the support portion 218 relative to the chair 100, and the other end of the support portion 218 (e.g., the top of the Y-shaped structural member) may be movably connected to the interior wall 204 by hinge joints or other connectors 206 that allow for motion (e.g., pivotal motion) of the support portion 218 relative to the interior wall 204. With this design, the massage chair 100 may be easily moved from a collapsed position adjacent to the interior wall 204 to an expanded position away from the interior wall 204 for use.

The massage chair 100 may further include, as described above, an integrated torso support 104 and a seat 106 connected to the frame structure 102. The integrated torso support 104 may include (a) an annular frame portion 108 having a frame opening 110 sized to accommodate a protruding abdomen of the pregnant or obese person, and (b) annular padding 112 configured for removable attachment to the annular frame portion 108. As discussed above, the annular padding 112 is designed to provide cushioning for regions of the torso (e.g., chest, hips) adjacent to the protruding abdomen that may be pressed against the annular frame portion 108 during the massage. The seat 106 of the massage chair is configured with a width sufficient to support a pregnant or obese person in a seated position. It is also contemplated that massage chairs having different features from the massage chair 100 described in this disclosure may be employed with the massage chair transport system 200. In some examples, suitable massage chairs do not necessarily need to be designed to accommodate pregnant or obese persons.

The massage chair 100 shown in FIGS. 9A and 9B may include any of the features described above or elsewhere in this disclosure. However, the massage chair 100 typically does not include leg rests 144, as shown in the example of FIG. 1. Such leg rests 144 provide support for the patient's shins while the legs are bent at an acute angle. In the example of FIG. 9B, to provide greater comfort to the patient and allow the patient to position his or her legs in a more relaxed position, the patient's feet may either rest on the floor or be placed within foot supports 222 that are movably attached to the interior wall 204 of the storage case 202. The foot supports 222 may be configured to pivot from a retracted position adjacent to the interior wall 204 (FIG. 9A) to an extended position away from the interior wall 204 (FIG. 9B) for use by the patient, as illustrated.

An arm rest for use by the patient may be provided by an arm support 216 movably connected to the interior wall 204 of the storage case 202. The arm support 216 may be attached by connectors 206 that allow for pivotal and/or sliding motion of the arm support 216. An exemplary connector 214 that permits the arm support 216 to be both translated and pivoted with respect to the interior wall 204 to achieve retracted and extended positions is illustrated in FIGS. 9A and 9B. When the frame structure 102 is in the collapsed configuration, the arm support 216 may be in the retracted position situated adjacent to the interior wall 204, as shown in FIG. 9A. When the frame structure 102 is in the expanded configuration, the arm support 214 may be in the extended position as shown in FIG. 9B so as to function as an arm rest for the patient. The arm support 216 need not be connected to the frame structure 102 of the massage chair 100, as with conventional massage chair designs. Some separation between the massage chair 100 and the extended arm support 216 while the chair 100 is in use may be beneficial to accommodate the protruding abdomen of the patient.

The storage case 202 may have a two-piece structure including an enclosure part 208 overlying the interior wall 204 and a separate cover part 210 configured for attachment to the enclosure part 208 to close the storage case 202. The storage case may include one or more fasteners 212 to attach the cover part 210 to the enclosure part 208, as shown in FIG. 9B. In some examples, the storage case 202 may include a zipper to attach the cover part 210 to the enclosure part 208. The storage case 202 may take the form of a hard-sided storage case made in full or in part of a rigid material, such as a polycarbonate (PC), polypropylene (PP) or acrylonitrile butadiene styrene (ABS) polymer. Alternatively, the storage case may take the form of a soft-sided storage case constructed in full or in part from a woven fabric, such as nylon, canvas, or polyester fabric, or from another durable soft material, such as leather. One or more pockets or compartments 226 may be integrated with an interior portion of the storage case 202 for holding supplies such as massage oil and disinfecting wipes.

The storage case 202 may further include wheels 220 and a retractable handle 224 to allow for easy movement of the case when the portable massage chair 100 is in the collapsed configuration and stored within the case 202. The handle 224 may be movable from a storage position, where a portion of the handle 224 is contained either inside the storage case 202 or in a receptacle on an outside surface of the storage case 202, to an extended position convenient for transporting the storage case 202, e.g., in a tilted position supported by the wheels 220. The handle 224 may be extracted from the storage position and retracted to the storage position via a sliding motion. After transport of the storage case 202 to a desired location for use or storage of the massage chair 100, the portion of the handle 224 may be returned to the storage position.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

In addition to the features mentioned in each of the independent aspects enumerated above, some examples may show, alone or in combination, the optional features mentioned in the dependent aspects and/or as disclosed in the description above and shown in the figures.

1. A massage chair comprising:
a frame structure;
an integrated torso support connected to the frame structure, the integrated torso support including:
an annular frame portion having a frame opening sized to accommodate a protruding abdomen of a pregnant or obese person; and
annular padding configured for removable attachment to the annular frame portion, the annular padding defining an abdominal opening sized to match or reduce the size of the frame opening; and
a seat connected to the frame structure, the seat being configured with a width sufficient to support a pregnant or obese person in a seated position.

2. The massage chair of claim 1, wherein the frame opening of the annular frame portion is at least 105 cm in perimeter or circumference.

3. The massage chair of claim 1, wherein the abdominal opening of the annular padding has a perimeter or circumference in a range from greater than 95 cm to 105 cm.

4. The massage chair of claim 1, wherein the abdominal opening of the annular padding has a perimeter or circumference in a range from greater than 90 cm to 95 cm.

5. The massage chair of claim 1, wherein the frame structure is a collapsible frame structure.

6. The massage chair of claim 1 including multiple sets of the annular padding, each set having an abdominal opening of a different perimeter or circumference.

7. The massage chair of claim 1, wherein the frame opening and the abdominal opening are circular, oval or elliptical in shape.

8. The massage chair of claim 1, wherein a back side of the annular padding comprises fastening strips for attachment to mating strips on a front side of the annular frame portion.

9. The massage chair of claim 1, wherein the seat has a width of at least 45 cm.

10. The massage chair of claim 1, wherein the frame structure is configured for height adjustment with extendable support legs.

11. The massage chair of claim 10, wherein each of the extendable support legs comprises telescoping members having an adjustable relative position, whereby a height of the chair may be adjusted in a range from 5 to 25 cm.

12. The massage chair of claim 1, wherein the frame structure is movably attached at one or more locations to an interior wall of a storage case, the frame structure being reversibly moveable from a collapsed configuration to an expanded configuration while remaining attached to the interior wall.

13. The massage chair of claim 12, wherein, when the frame structure is in the collapsed configuration, the massage chair is enclosable within the storage case, and
wherein, when the frame structure is in the expanded configuration, the massage chair is usable to support a patient for a massage or other procedure.

14. A massage chair transport system comprising:
a storage case; and
a massage chair having a frame structure movably attached at one or more locations to an interior wall of the storage case, the frame structure being reversibly movable from a collapsed configuration to an expanded configuration while remaining attached to the interior wall,
wherein the massage chair is enclosable within the storage case when the frame structure is in the collapsed configuration,
wherein the massage chair is usable to support a patient for a massage or other procedure when the frame structure is in the expanded configuration.

15. The massage chair transport system of claim 14, wherein the movable attachment of the frame structure is enabled by connectors configured to allow pivotal, rotational, translational and/or sliding motion.

16. The massage chair transport system of claim 14 wherein the storage case has a two-piece structure comprising an enclosure part overlying the interior wall and a separate cover part configured for attachment to the enclosure part to close the storage case.

17. The massage chair transport system of claim 14, further comprising an arm support moveably attached to the interior wall of the storage case, the arm support being configured to be reversibly moved from a retracted position to an extended position for use by a patient.

18. The massage chair transport system of claim 14, further comprising a foot support movably attached to the interior wall of the storage case, the foot support being configured to be reversibly moved from a retracted position to an extended position for use by a patient.

19. The massage chair transport system of claim 14, further comprising one or more pockets or compartments integrated with an interior portion of the storage case for holding supplies.

20. The massage chair transport system of claim 14, further comprising:
an integrated torso support connected to the frame structure, the integrated torso support including:
an annular frame portion having a frame opening sized to accommodate a protruding abdomen of a pregnant or obese person; and
annular padding configured for removable attachment to the annular frame portion, the annular padding defining an abdominal opening sized to match or reduce the size of the frame opening; and
a seat connected to the frame structure, the seat being configured with a width sufficient to support a pregnant or obese person in a seated position.
